(19) United States
(12) Patent Application Publication
(10) Pub. No.: US 2022/0018673 A1
(43) Pub. Date: Jan. 20, 2022

(54) CHOICE MODELING FOR PICKUP MAP DISPLAY CONTENT

(71) Applicant: Uber Technologies, Inc., San Francisco, CA (US)

(72) Inventor: Saebra Lynn Waterstraut, San Francisco, CA (US)

(21) Appl. No.: 17/305,853

(22) Filed: Jul. 15, 2021

Related U.S. Application Data
(60) Provisional application No. 62/705,810, filed on Jul. 16, 2020.

(51) Int. Cl. G01C 21/34; G01C 21/36; G06F 16/29; G06Q 50/30

(52) U.S. Cl. CPC G01C 21/3476; G01C 21/367; G06Q 50/30; G01C 21/3691; G06F 16/29; G01C 21/3484

(57) ABSTRACT

Systems and methods are directed using a machine learning model to determine content to display on a map. The system detects an event associated with a transportation service being requested via an application on a user device of a user. The system accesses real-time data (e.g., sensor data indicating location of the user device) and historical data associated with the user. The system also determines connectivity for a location of the client device. The connectivity can include one or more of a load time for an area that the user device is located, battery life of the user device, or network strength of a connection. Next, the system analyzes the accessed data and the connectivity to identify display elements to present on the client device based on the event. The system then causes presentation of the display elements on the client device.

### CLAIM FOR PRIORITY

This application claims the benefit of priority of U.S. Application Ser. No. 62/705,810, filed Jul. 16, 2020, which is hereby incorporated by reference in its entirety.

### TECHNICAL FIELD

The subject matter disclosed herein generally relates to causing display of map content. Specifically, the present disclosure addresses systems and methods that use a machine learning model to determine content to display on a map before, during, and after pickup for a transportation service.

### BACKGROUND

Conventionally, pickup is the most daunting and ongoing problem for transportation companies (e.g., ridesharing companies). It is consistently the most frustrating part of the transportation experience and often leads to cancellations and/or altercations between a rider and a driver.

### BRIEF DESCRIPTION OF THE DRAWINGS

Some embodiments are illustrated by way of example and not limitation in the figures of the accompanying drawings.

FIG. 1 is a diagram illustrating a network environment suitable for choice modeling for pickup map display content, according to some example embodiments.

FIG. 2 is a block diagram illustrating components of a network system for choice modeling for pickup map display content, according to some example embodiments.

FIG. 3 is a flowchart illustrating operations of a method for generating and causing presentation of display elements based on choice modeling, according to some example embodiments.

FIG. 4 is a flowchart illustrating operations of a method for identifying display elements, according to some example embodiments.

FIG. 5 is a block diagram illustrating components of a machine, according to some example embodiments, able to read instructions from a machine-storage medium and perform any one or more of the methodologies discussed herein.

### DETAILED DESCRIPTION

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without some or other of these specific details. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

The present disclosure provides technical solutions using choice modeling to generate pickup map display content. Using a choice model, a network system surfaces solutions, map data, and communications tools based on circumstances of a user (e.g., a rider or requester) resulting in limiting the amount of constant on-screen features while providing exactly what the user needs to negotiate a pickup location or to navigate to the pickup location given their environment. The network system hyper-contextualizes for the user based on location specific criteria or parameters (e.g., traffic levels, population density, connectivity, map granularity, user familiarity with the location, location complexity), and environmental criteria. More specifically, the network system analyzes the user's historical data as well as real-time location-based information to determine content to provide to the user. The network system identifies one or more of complexity, familiarity, and connectivity associated with the user in determining the content. The content includes, for example, a level of view of an area about the user, number and types of point of interests (POIs) to surface on a map, and notifications.

Familiarity (or a familiarity score) is based on user history such as whether the user has been to the location, neighborhood, or city before (e.g., three tiers of familiarity). For example, if the user has never been to the location, the network system will populate more POIs that are street visible to the user and/or, for places without street names, remove the unnamed road and show POIs instead. In another example, if the user does not speak the language or has never been to the location, the network system can show an image of the pickup point (e.g., so the user does not need to read foreign signs).

Complexity (or complexity score) may also be based on user history as well as location specific information, such as, if an area around a pickup point is congested or is complex (e.g., an airport with multiple exits). Complexity may also affect the user's elasticity (e.g., willingness to move or deviate from their current position). For instance, the user history may indicate if the user always crosses the street or cancels if the driver is on the opposite side of the street, if they are willing to walk a block or more to get to a better pickup point (e.g., faster pickup), and other past behaviors.

Connectivity is based on history and real-time data for a market (e.g., area where transportation service is provided). The network system will know what the load times will likely be for a market and adjust content accordingly. For example, if the user is somewhere with low connectivity, lots of POIs may crash the application, so the network system will show less POIs or less intense graphics. The content is prioritized in a certain way to ensure that the user receives the right amount of information at the right time. For instance, in Alexandria (Egypt), users usually search for mosques and malls, so the network system may only load POIs for mosques and malls or load those POIs first.

The network system provides a model that attempts to understand variables users used to make decisions regarding a pickup process. The model is based on a list of factors that affect decision making in setting and arriving at a pickup point and based on an order that users typically want to see geo-information presented. For example, a user, when they first open a transportation service application will want to identify where they are and then the things around them. Next, the user will need to identify the block or neighborhood they are on and finally, what nearby landmarks or points of interests (POIs) surround them in order to orient themselves. As such, a user interface provided to the user in this stage of the transportation service (e.g., between opening the application and requesting the transportation service) may provide a zoom out from where the user is up to nearby POIs. Once a request for transportation service is sent, the user will want to know what direction the service provider is coming from and where the user is in relations (e.g., what block am I on). Then, the user will want to know the nearby POIs, and finally what the driver's location is. Therefore, the user interface provided in the stage between making the transportation request and pickup will provide a zoom in from the direction the driver is coming from to a driver's location at or right before pickup. Thus, a user experiences a period of orientation that starts with their current location moving outward to verify their destination before converging to monitor the service provider's arrival and find their vehicle in example embodiments.

The network system identifies, based on (mobile) events and as the stages progress, correct type and amount of information to provide to the user. The network system can also use real-time sensor data to identify, for example, if the user is walking in a wrong direction from a pickup point or a direction a service provider is coming from. Thus, the network system can use a combination of real-time sensing, stored past trip data, and an understanding of the overall process to determine and provide customized display content to the user.

The following provides various use cases that exemplify usage of example embodiments. In a first user case, a user is getting picked up from a friend's house (low complexity) in a new neighborhood (unfamiliar) and wants to go home. The user does not have any technical problems (e.g., battery, signal strength, device quality). The user is in a locale with good data coverage (good connectivity) and an area with many points of interests (POIs). As such, when the user makes a request for transportation service, the network system shows a destination on a map (current flow), whereby the destination or dropoff point is “Home.” When asked to refine a pickup point, the user interface zooms in and shows more POIs nearby. Corner POIs may have priority, then visible street, then general content. A pin for the pickup location is set and the ride requested (current route overview experience). When the user prepares to navigate to the pickup point, the network system returns to a heavily populated POI formatting to give the user more guidance. Therefore, for this use case, (1) a homescreen is more zoomed in; (2) a destination is more zoomed in; (3) the map is zoomed in and heavily populated with POIs for pickup refinement; (4) the POI display is prioritized by corners, local relevance, and street visibility; and (5) factors taken into consideration include complexity, familiarity, and connectivity (include technology availability).

In a second user case, the user is getting picked up from home (familiar) and dropped off at a destination entered via latitude/longitude. This often implies the destination has been shared by a friend and copied and pasted from a mapping application (e.g., Google Maps, Apple Maps). The network system confirms the user is at home (e.g., using a one-tap button or confirmation click). When setting a destination, the network system heavily populates locally relevant POIs and controls zoom level based on highly referenced POIs (within a certain radius), is persistent with street names, and shows neighborhood name on screen during display of a route overview screen. Pickup refinement is skipped since the user is familiar with the pickup point (e.g., based on the one-tap or confirmation click which causes the pickup refinement flow to be skipped).

In a third use case, the user is getting picked up at work (familiar) with no technology problems in a poor data coverage market (e.g., India, Egypt, Japan) to be taken to a destination in an area without many POIs. When the destination is set (e.g., a saved place or place with address), pickup refinement is skipped because the pickup point is familiar and has been confirmed. A route overview screen shows recent and/or frequent pickup/dropoff points on the map (e.g., work->new restaurant shows “Home” pin, favorite cafe pin, and any saved places). This requires less data because the locations are saved and can provide reference points for the user to confirm their destination without resorting to using a third-party application or map to verify. This use case has low POI density and/or coverage reaction and provides personalized POIs based on connectivity (e.g., being low) and availability of POIs (e.g., another form of more heavily populating the map but with data the network system has confidence of). Additionally, the pickup refinement is skipped since the user is familiar with the pickup point and given the low connectivity.

In a fourth use case, the network system detects, based on sensor data, that the user (e.g., a rider) is walking away from a pickup point or is heading in an opposite direction of a driver. The network system sends a notification to the user to head towards a locally relevant or street visible POI. This may occur, for example, based on the driver being within 100 meters of the pickup point. This use case provides navigation notification to the user when needed and acknowledges that the user is going the wrong way. The notification is based, for example, by referring to the driver's distance from the pickup point before directing the user (e.g., in case the driver reroutes or is communicated a new pickup point). Additionally, a POI is communicated to the user as a navigation guide.

In a fifth use case, the user (e.g., rider) is in an unfamiliar location at a complex venue (e.g., apartment building or market with several exits) with high transportation requests within a predetermine distance of the user's location (e.g., with 100 meters of the user's GPS location). Here, the network system provides street view imagery for hyper-specific pickup refinement. The user and driver may both see the imagery. In some cases, as the driver nears the pickup point, the rider may be prompted to contact the driver or vice-versa. As such, this use case provides imagery due to the complexity of the pickup point.

In a sixth use case, the user has a low-end device, poor connectivity, not great POI coverage or density in the area, and in a market where contacts (e.g., communications between the user and driver) are high. The pickup refinement flow is skipped due to the device limitations, poor connectivity, and low POI coverage/density. Instead, the user confirms a general area, such as a zone since the user will likely need to move to a different location for pickup. After the ride is requested, contact options (e.g., text or call option) take up a larger portion of the screen on the user's device. In this use case, the user receives a push to contact the driver to negotiate the pickup point based on a market-average contact rate being high as well as low POI coverage and poor connectivity.

In a seventh use case, the user is in an area where most applications are not in the same language as their own. For example, the user is traveling in a foreign country. The network system detects an increase in complexity and a decrease in familiarity in this situation. As such, the network system provides a street image to the user to reduce the need for verbal communication.

In an eighth use case, the user is in an unfamiliar location and has a low elasticity rating (e.g., will not or cannot travel from their current location). In an unfamiliar area, the user's dispatch (e.g., the driver/service provider) will be routed to the user's side of the street with a notification that the user is not able to move from that location. Alternatively, if the user is in a familiar location, the network system may prompt the user with a request to cross the street to save some time. Here, the user is only prompted or asked (instead of being forced to move) since the user has a low elasticity rating or score.

A ninth use case provides a user requesting a transportation service to an unfamiliar area. In a destination confirmation screen and route overview, the network system provides relational information about the dropoff point (e.g., “in the Haight” or “near Tahrir square” or “Exit 9”) depending on the market. This way, the user can more confidently set their destination. The surfaced POIs are locally relevant or personally relevant.

As a result, one or more of the methodologies described herein facilitate solving the technical problem of displaying content on a map that ensures user comprehension. Example embodiments use stored trip data, real-time information, user history and preferences, and/or known or derived facts for an area to determine one or more of complexity, familiarity, and connectivity associated with a user. Based on these parameters, appropriate information on the map can be customized for the user. As such, one or more of the methodologies described herein may obviate a need for certain efforts or computing resources that otherwise would be involved with the user using their device to determine where they are and/or where they need to travel to. Examples of such computing resources include processor cycles, network traffic, memory usage, data storage capacity, power consumption, network bandwidth, and cooling capacity

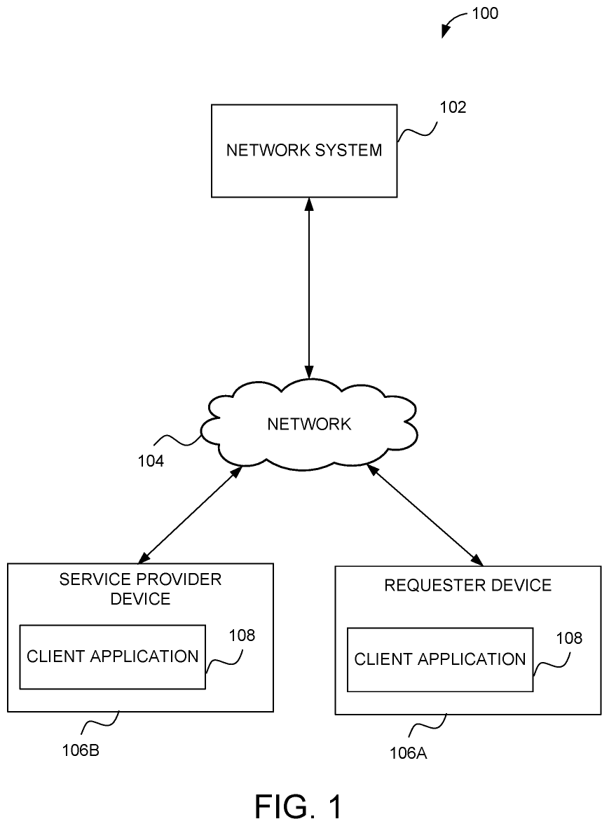

FIG. 1 is a diagram illustrating a network environment 100 suitable for using choice modeling to provide customized pickup map content to a user (e.g., a rider), in accordance with example embodiments. The network environment 100 includes a network system 102 communicatively coupled via a network 104 to a requester device 106a of a user or rider and a service provider device 106b of a driver (collectively referred to as “user devices 106”).

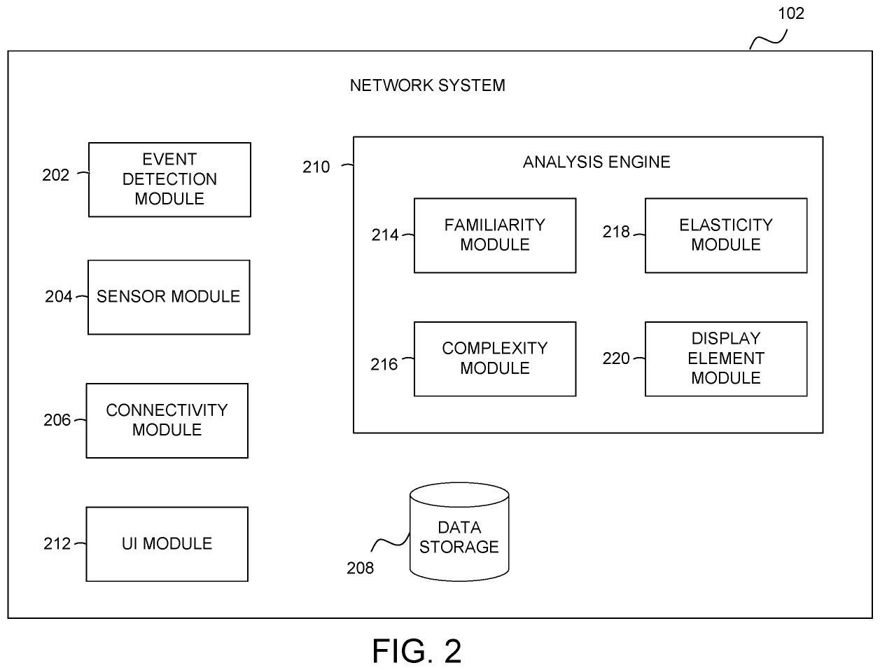

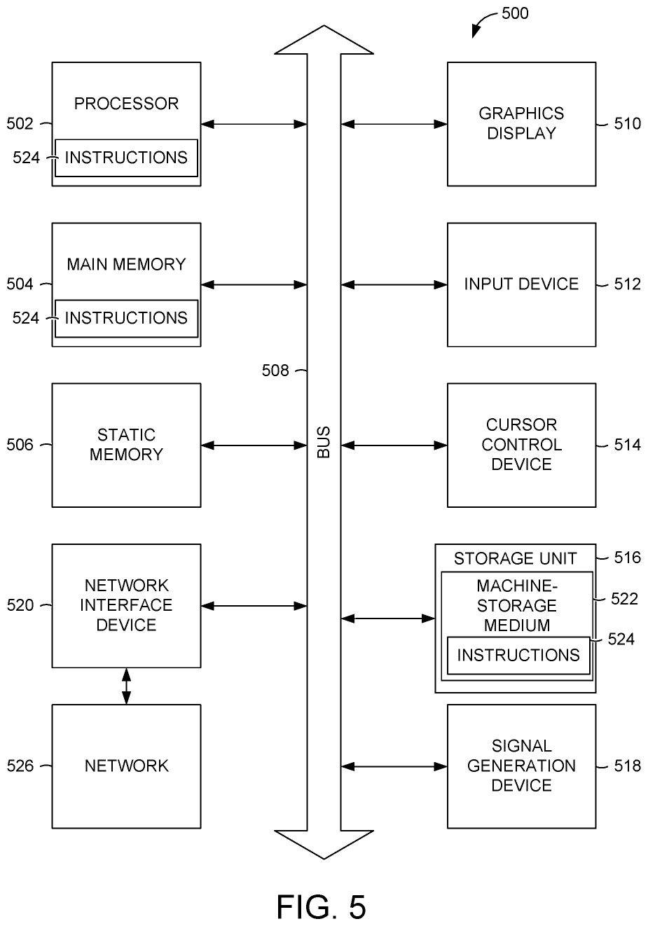

In example embodiments, the network system 102 comprises components that obtain, store, and analyze trip data received from the user devices 106 in order to determine parameters from past trips (e.g., routes traveled, pickup points, destinations) and learn user preferences from the past trips. Trip data also includes (substantially) real-time trip data that allows the network system 102 to monitor devices of users (via sensors in their user devices) and detect, for example, if the users are in a correct location for pickup, connectivity in the location of the users, and device data (e.g., low battery). The network system 102 then determines customized pickup map content to present to the users based on various factors, as discussed in more detail herein. The components of the network system 102 are described in more detail in connection with FIG. 2 and may be implemented in a computer system, as described below with respect to FIG. 5. While some embodiments are described in the context of a transportation service (e.g., to transport a person), example embodiments may also be used in delivery embodiments (e.g., to deliver an item).

The components of FIG. 1 are communicatively coupled via the network 104. One or more portions of the network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a Wi-Fi network, a WiMax network, a satellite network, a cable network, a broadcast network, another type of network, or a combination of two or more such networks. Any one or more portions of the network 104 may communicate information via a transmission or signal medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

In example embodiments, the user devices 106 are portable electronic devices such as smartphones, tablet devices, wearable computing devices (e.g., smartwatches), or similar devices. Alternatively, the service provider device 106b can correspond to an on-board computing system of a vehicle. The user devices 106 each comprises one or more processors, memory, touch screen displays, wireless networking system (e.g., IEEE 802.11), cellular telephony support (e.g., LTE/GSM/UMTS/CDMA/HSDP A), and/or location determination capabilities.

The user devices 106 interact with the network system 102 through a client application 108 stored thereon. The client application 108 of the user devices 106 allow for exchange of information with the network system 102 via user interfaces, as well as in background. For example, the client application 108 running on the user devices 106 may determine and/or provide event data (e.g., where on the client application 108 is the user—just opened the client application 108, setting a destination, setting a pickup point, requesting service), location information of the user devices 106 (e.g., current location in latitude and longitude), speed, and device data (e.g., battery life, signal strength) to the network system 102, via the network 104, for analysis and storage. The network system 102 then determines and provides customized map content to the user devices 106.

In example embodiments, a first user (e.g., a requester or rider) operates the requester device 106a that executes the client application 108 to communicate with the network system 102 to make a request for a transportation service such as transport or delivery service (referred to collectively as a “trip”). The client application 108 is associated with various events that are detected by the network system 102. The events include, for example, opening the client application 108, searching a destination, presenting a route to the destination, making a request for transportation service, waiting for pickup (or navigating to a pickup point), and during transportation to the destination. In some embodiments, the client application 108 determines or allows the user to specify/select a pickup location (e.g., of the user or an item to be delivered) and to specify a drop-off location or destination for the trip.

A second user (e.g., a service provider or driver) operates the service provider device 106b to execute the client application 108 that communicates with the network system 102 to exchange information associated with providing transportation service (e.g., to the user of the requester device 106a). The client application 108 presents information via user interfaces to the user of the service provider device 106b, such as invitations to provide the transportation service, route and navigation instructions to a pickup point of the user (e.g., rider), and/or route and navigation instructions to a destination after pickup of the user. The client application 108 also provides data to the network system 102, such as a current location (e.g., coordinates such as latitude and longitude), speed, and/or heading of the service provider device 106b or vehicle.

In example embodiments, any of the systems, machines, databases, or devices (collectively referred to as “components”) shown in, or associated with, FIG. 1 may be, include, or otherwise be implemented in a special-purpose (e.g., specialized or otherwise non-generic) computer that has been modified (e.g., configured or programmed by software, such as one or more software modules of an application, operating system, firmware, middleware, or other program) to perform one or more of the functions described herein for that system or machine. For example, a special-purpose computer system able to implement any one or more of the methodologies described herein is discussed below with respect to FIG. 5, and such a special-purpose computer may be a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

Moreover, any two or more of the systems or devices illustrated in FIG. 1 may be combined into a single system or device, and the functions described herein for any single system or device may be subdivided among multiple systems or devices. Additionally, any number of user devices 106 may be embodied within the network environment 100. Furthermore, some components or functions of the network environment 100 may be combined or located elsewhere in the network environment 100. For example, some of the functions of the networked system 102 may be embodied within other systems or devices of the network environment 100. Additionally, some of the functions of the user device 106 may be embodied within the network system 102. While only a single network system 102 is shown, alternative embodiments may contemplate having more than one network system 102 to perform server operations discussed herein for the network system 102.

FIG. 2 is a block diagram illustrating components of the network system 102, according to some example embodiments. In various embodiments, the network system 102 obtains and analyzes data including sensor data and trip data (e.g., indicated origin and destination, routes, locations of user devices, speed) received from the user devices 106, determines a level of zoom, determines a number and type of display content to provide to users, and causes presentation of the display content at the user devices. To enable these operations, the network system 102 comprises an event detection module 202, a sensor module 204, a connectivity module 206, a data storage 208, an analysis engine 210, and a user interface (UI) module 212 all configured to communicate with each other (e.g., via a bus, shared memory, or a switch). The network system 102 may also comprise other components (not shown) that are not pertinent to example embodiments. Furthermore, any one or more of the components (e.g., engines, interfaces, modules, storage) described herein may be implemented using hardware (e.g., a processor of a machine) or a combination of hardware and software. Moreover, any two or more of these components may be combined into a single component, and the functions described herein for a single component may be subdivided among multiple components.

The event detection module 202 is configured to determine where, in a series of events, a user and/or their client application 108 is in during a transportation request/service flow. In various embodiments, the events for a user can include opening the client application 108, requesting a transportation service (e.g., searching for a destination and confirming the request), navigating/arriving at a pickup point, and/or trip start. As such, the event detection module 202 detects where the user is on the client application 108 in the transportation request process. Different events are associated with different levels (of zoom) and type of content to display to the user.

The sensor module 204 is configured to access sensor information from sensors associated with the user device 106. The sensor information may include location information (e.g., GPS coordinates) that indicates a position of the user as well as a direction that the user is traveling to get to a pickup point. For example, the sensor information can detect if the user is walking in a wrong direction from a pickup point or a direction a service provider is coming from.

The connectivity module 206 is configured to determine connectivity associated with the user device 106. In example embodiments, the connectivity is based on historical and real-time data for a market (e.g., area where transportation service is provided). As such, the connectivity module 206 can access or determine what the load times (e.g., to load a map) will likely be for a market (e.g., area the user is in). In some embodiments, the load time are stored in the data storage 208. In other embodiments, the connectivity module 206 can detect real-time connectivity status of the user device 106 making the transportation request. In some embodiments, the connectivity module 206 is a part of the analysis engine 210.

The data storage 208 is configured to store information associated with each user of the network system 102 including trip data. The stored information includes, for example, past trips, saved or frequently selected locations (e.g., home, work), explicit preferences (e.g., language), and/or implicit preferences (e.g., whether the user is willing to walk to a pickup point if it is more convenient or will save them time or money). In some embodiments, the data is stored in or associated with a user profile corresponding to each user and includes a history of interactions using the network system 102. While the data storage 208 is shown to be embodied within the network system 102, alternative embodiments can locate the data storage 208 elsewhere and be communicatively coupled to the network system 102.

The analysis engine 210 analyzes event data, sensor data, connectivity, and stored user information to determine what level of zoom and content to display to the user at various stages of a transportation service. More specifically, the analysis engine 210 analyzes the user's historical data as well as real-time location-based information to determine the content to provide to the user. The analysis engine 210 identifies one or more of complexity, familiarity, and connectivity associated with the user in determining the content. To enable these operations, the analysis engine 210 includes a familiarity module 214, a complexity module 216, an elasticity module 218, and a display element module 220.

The familiarity module 214 determines familiarity (e.g., a familiarity score) of a location to a user. The familiarity may be based on user history such as whether the user has been to the location, neighborhood, or city before. Familiarity can also include whether the user speaks the local language or whether the user has been to the location before. In various embodiments, if the user has never been to the location, the analysis engine 210 may provide more POIs that are street visible to the user and/or, for places without street names, remove the unnamed road and show POIs instead. Furthermore, if the user does not speak the language or has never been to the location, the analysis engine 210 may show an image of the pickup point (e.g., so the user does not need to read foreign signs).

The complexity module 216 determines complexity (e.g., a complexity score) of the location to the user. The complexity may also be based on user history as well as location specific information, such as, if an area around a pickup point is congested or is complex (e.g., having multiple entrances/exits). The location specific information may be determined over time based, for example, on past trips to/from that location for a plurality of users. In some embodiments, the complexity module 216 works with the sensor module 204 to deduce, from the number of users requesting transportation service in a particular area or heavy traffic (e.g., telemetric information from vehicles), that the area is congested.

The elasticity module 218 determines a user's elasticity. Elasticity indicates the user's willingness to move or deviate from their current position to navigate to a pickup point that is in a different location. The elasticity module 218 examines the user historical data (e.g., stored in the data storage 208) to determine how willing the user is to move. For instance, the user history may indicate whether the user always cross the street or cancels if the driver is on the opposite side of the street, whether they are willing to walk a block or more to get to a better pickup point (e.g., faster pickup; less congested), and other past behaviors. In some cases, complexity may affect the user's elasticity. For instance, if the location is very congested, the user may be more willing to walk to a pickup point a block or two away in order to make the pickup easier.

The display element module 220 takes the various parameters (e.g., event data, familiarity, complexity, elasticity, connectivity) and determines the level of zoom and/or number and type of content to provide to the user. The parameters are weighed against each other, and various combinations are considered in determining the level and content. For example, if the area is complex, connectivity is low, but the user is familiar with the area, less POIs may be provided to user. However, if the user is not familiar with the area, imagery of the pickup point may be provided and/or a notification to call the driver provided. Alternatively, if the area is complex, connectivity is high, but the user is not familiar with the area, a lot of POIs may be provided. In various cases, some parameters are more important than others and may be weighted accordingly. For example, familiarity may be more important than complexity, and complexity may be more important than elasticity.

In one embodiment machine learning can be used to train a choice model. For example, features based on events and past trip data (e.g., combinations of familiarity, complexity, and/or elasticity scores) and data shown or requested to be shown can be used to train a machine learning model (e.g., the choice model), such that given certain features (e.g., event and specific combination of familiarity, complexity, and/or elasticity scores), a certain level (of zoom) and type of content is displayed (or requested to be displayed). During runtime, the choice model can be applied to real-time and historical data associated with a user requesting transportation service to determine the level and type of content to be presented to the user. Thus, using the choice model, the network system 102 can surface solutions, map data, and communications tools based on circumstances of the user which results in limiting the amount of constant on-screen features being shown while providing exactly what the user needs to negotiate a pickup location or to navigate to the pickup location given their environment.

Once the level and content is determined, the display element module 220 provides the information to the UI module 212, which causes display of a UI at the client device 106 (e.g., transmits instructions to the client device 106 to display the UI) that includes one or more of a map, POIs, imagery, and/or notifications.

The network system 102 also includes a routing engine (not shown) which is configured to generate routes and monitor navigation of routes. The routes may include a route from a current location of the service provider to a pickup point, a route from a current location of the user to the pickup point, and/or a route from the pickup point to a destination. The UI module 212 also causes the display of the route on the UI at the client device 106.

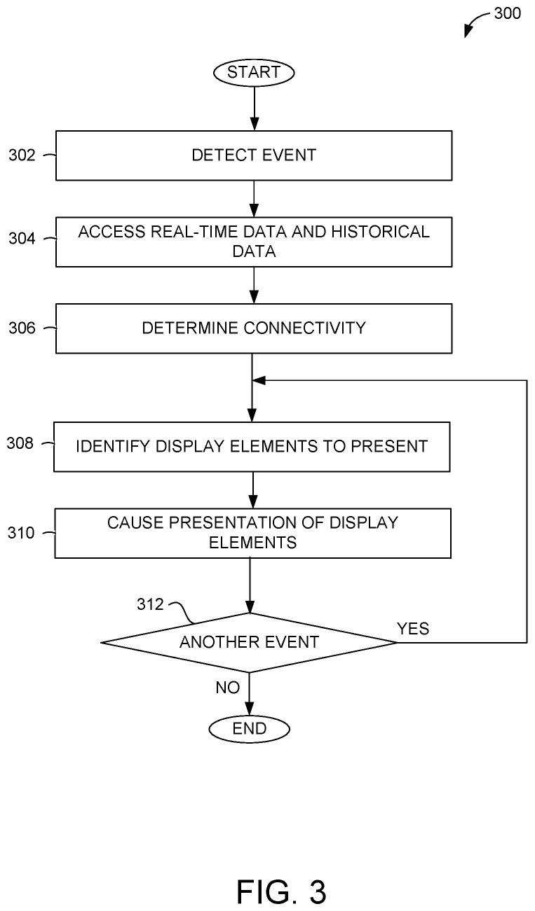

FIG. 3 is a flowchart illustrating operations of a method 300 for generating and causing display of map content based on choice modeling, according to some example embodiments. Operations in the method 300 may be performed by the network system 102, using components described above with respect to FIG. 2. Accordingly, the method 300 is described by way of example with reference to the network system 102. However, it shall be appreciated that at least some of the operations of the method 300 may be deployed on various other hardware configurations or be performed by similar components residing elsewhere in the network environment 100. Therefore, the method 300 is not intended to be limited to the network system 102.

In operation 302, the event detection module 202 detects an event associated with the client application during a transportation request/service flow. The events associated with the user can include, for example, opening the client application 108, requesting a transportation service (e.g., searching for a destination and confirming the request), navigating/arriving at a pickup point, and trip start (e.g., traveling to the destination). As such, the event detection module 202 detects where the user is on the client application 108 in the transportation request process. Different events are associated with different levels (of zoom) and type of content to display to the user.

In operation 304, real-time and historical data is accessed. The real-time data may include sensor information as well as connectivity information for the client device of the user. Accordingly, the sensor module 204 accesses sensor information from sensors associated with the user device 106. The sensor information may include location information (e.g., GPS coordinates) that indicates a position of the user during the request process. The location information can also include a direction that the user is traveling to get to a pickup point after a request for transportation service has been confirmed. For example, the sensor information can detect if the user is walking in a wrong direction from a pickup point or from a direction a service provider is coming from. Additionally, the connectivity module 206 may detect real-time connectivity status of the user device 106 making the transportation request. The real-time connectivity status of the user device can include battery life and device connectivity level (e.g., network strength of connection).

The historical data comprises information stored at the data storage 208 including preferences. The stored information includes, for example, past trips, saved or frequently selected locations (e.g., home, work), explicit preferences (e.g., language), and/or implicit preferences (e.g., whether the user is willing to walk to a pickup point if it is more convenient or will save them time or money). In some embodiments, the data is stored in or associated with a user profile corresponding to each user and includes a history of interactions using the network system 102.

In operation 306, the connectivity module 206 determines connectivity for an area that the user is located. In example embodiments, the connectivity is based on historical and real-time data for a market (e.g., area where transportation service is provided). As such, the connectivity module 206 can access or determine what load times will likely be for a market (e.g., area the user is in). In some embodiments, the load time are stored in the data storage 208.

In operation 308, the analysis engine 210 identifies display elements to present (e.g., level of zoom and content). In example embodiments, the analysis engine 210 analyzes event data, sensor data, connectivity information, and stored user information to determine the level of zoom and content to display to the user at various stages (e.g., events) of the transportation service. More specifically, the analysis engine 210 applies a choice model to determine the display elements.

In some embodiments, more than one set of display elements may be determined. For example, if the event is opening the application, the analysis engine 210 may determine a first set of display elements that shows the user's zoomed in location on a map. The analysis engine 210 may then determine a second set of display elements that zooms out to allow the user to orient themselves in the area.

In operation 310, the UI module 212 causes display of the UI with the display elements at an appropriate level of zoom. The display elements include one or more of a map, POIs, imagery, and notifications. In some embodiments, the UI module 212 generates the UI and/or transmits instructions to the client device 106 to display the UI.

In operation 312, a determination is made whether another event is detected. If another event is detected, the method 300 returns to operation 308 where a next set of display elements is determined.

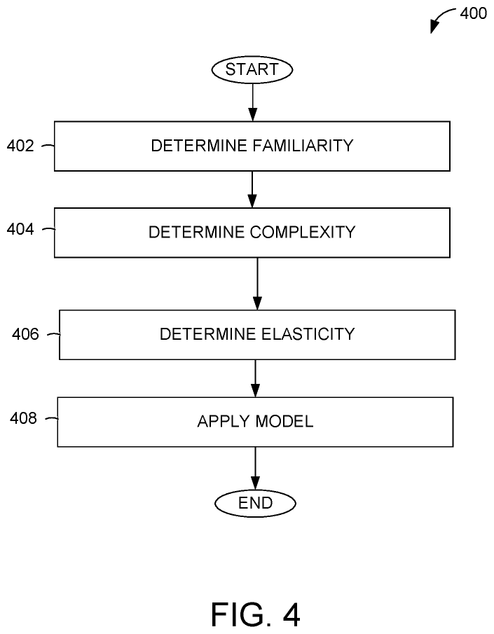

FIG. 4 is a flowchart illustrating operations of a method 400 (e.g., operation 308) for identifying display elements, according to some example embodiments. Operations in the method 400 may be performed by the network system 102 (e.g., analysis engine 210), using components described above with respect to FIG. 2. Accordingly, the method 400 is described by way of example with reference to the network system 102. However, it shall be appreciated that at least some of the operations of the method 400 may be deployed on various other hardware configurations or be performed by similar components residing elsewhere in the network environment 100. Therefore, the method 400 is not intended to be limited to the network system 102.

In operation 402, the familiarity module 214 determines familiarity of a location to a user. The familiarity may be based on user history (e.g., historical data from the data storage 208) such as whether the user has been to the location, neighborhood, or city before. Familiarity can also include whether the user speaks the local language (e.g., based on user preference). The familiarity may be identified as a familiarity parameter or score in some embodiments. The familiarity score may be based on a range (e.g., from 0 to 1; from 0 to 10), where a lower number indicates less familiarity while a higher number indicates more familiarity. The score can be adjusted or weighted, for example, based on a type of familiarity (e.g., “home” or “work” location is adjusted or weighted higher than a restaurant the user has been to several times) and/or a number of times the user has been at the location.

In operation 404, complexity module 216 determines complexity of the location of the user. The complexity may be based on location specific information, such as, if an area around a pickup point is congested or is complicated (e.g., having multiple entrances/exits). The location specific information may be determined over time based, for example, on past trips to/from that location for a plurality of users. For example, if multiple users have requested a pickup form the same location but indicated different pickup points associated with different exits, the complexity module 216 determines the location has multiple exits. In other embodiments, the complexity module 216 can infer from a type of location that it is complex. For instance, an airport or a shopping mall will have multiple entrances/exits. In some embodiments, the complexity module 216 works with the sensor module 204 to deduce, from the number of users requesting transportation service in a particular area or heavy traffic (e.g., telemetric information from vehicles) that the area is congested. This determination of complexity of a location may occur in real-time, be pre-determined and accessed from the data storage 208, or a combination of both.

The complexity may be identified as a complexity parameter or score in some embodiments. Similar to the familiarity score, the complexity score may be based on a range (e.g., from 0 to 1; from 0 to 10), where a lower number indicates less complexity while a higher number indicates more complexity. The score can be adjusted or weighted, for example, based the level of congestion, number of roads surrounding the location, and/or number of entrances/exits.

In operation 406, the elasticity module 218 determines elasticity of a user. Elasticity indicates the user's willingness to move from their current location to a pickup point that is in a different location. The elasticity module 218 examines the user historical data (e.g., stored in the data storage 208) to determine how willing the user has been to move in the past. For instance, the user history may indicate whether the user always cross the street or cancels if the driver is on the opposite side of the street, whether they are willing to walk a block or more to get to a better pickup point (e.g., faster pickup; less congested), and other past behaviors. In some embodiments, the elasticity may be location based. For example, the user may be more willing to move (e.g., be more elastic) around their work, but less likely to be elastic at the mall (e.g., because the user is carrying a lot of packages).

Here too, the elasticity may be identified as an elasticity parameter or score. The complexity score may be based on a range (e.g., from 0 to 1; from 0 to 10), where a lower number indicates less elasticity while a higher number indicates more elasticity. The score can be adjusted or weighted, for example, based a number of times the user has been willing to move and the location of the user.

In operation 408, the display element module 220 applies the choice model. In example embodiments, the display element module 220 applies the choice model to the various parameters (e.g., scores) to determine the display elements. That is, the application of the choice model to the combination of parameters provides the display elements (e.g., the level of zoom, number and type of content). In some embodiments, the various parameters may be weighted. For example, familiarity may be more important (and weighted higher) than complexity, and complexity may be more important than elasticity. The various use cases discussed herein provide some examples of how the combination of parameters effect what gets displayed to the user.

In some embodiments, the display elements are customized to the user. For example, the display element module 220 may select the same display elements that were presented the last time similar parameters or scores were identified for the user.

FIG. 5 illustrates components of a machine 500, according to some example embodiments, that is able to read instructions from a machine-storage medium (e.g., a machine-readable storage device, a non-transitory machine-readable storage medium, a computer-readable storage medium, or any suitable combination thereof) and perform any one or more of the methodologies discussed herein. Specifically, FIG. 5 shows a diagrammatic representation of the machine 500 in the example form of a computer device (e.g., a computer) and within which instructions 524 (e.g., software, a program, an application, an applet, an app, or other executable code) for causing the machine 500 to perform any one or more of the methodologies discussed herein may be executed, in whole or in part.

For example, the instructions 524 may cause the machine 500 to execute the flow diagrams of FIGS. 3 and 4. In one embodiment, the instructions 524 can transform the general, non-programmed machine 500 into a particular machine (e.g., specially configured machine) programmed to carry out the described and illustrated functions in the manner described.

In alternative embodiments, the machine 500 operates as a standalone device or may be connected (e.g., networked) to other machines. In a networked deployment, the machine 500 may operate in the capacity of a server machine or a client machine in a server-client network environment, or as a peer machine in a peer-to-peer (or distributed) network environment. The machine 500 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 524 (sequentially or otherwise) that specify actions to be taken by that machine. Further, while only a single machine is illustrated, the term “machine” shall also be taken to include a collection of machines that individually or jointly execute the instructions 524 to perform any one or more of the methodologies discussed herein.

The machine 500 includes a processor 502 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 504, and a static memory 506, which are configured to communicate with each other via a bus 508. The processor 502 may contain microcircuits that are configurable, temporarily or permanently, by some or all of the instructions 524 such that the processor 502 is configurable to perform any one or more of the methodologies described herein, in whole or in part. For example, a set of one or more microcircuits of the processor 502 may be configurable to execute one or more modules (e.g., software modules) described herein.

The machine 500 may further include a graphics display 510 (e.g., a plasma display panel (PDP), a light emitting diode (LED) display, a liquid crystal display (LCD), a projector, or a cathode ray tube (CRT), or any other display capable of displaying graphics or video). The machine 500 may also include an input device 512 (e.g., a keyboard), a cursor control device 514 (e.g., a mouse, a touchpad, a trackball, a joystick, a motion sensor, or other pointing instrument), a storage unit 516, a signal generation device 518 (e.g., a sound card, an amplifier, a speaker, a headphone jack, or any suitable combination thereof), and a network interface device 520.

The storage unit 516 includes a machine-storage medium 522 (e.g., a tangible machine-readable storage medium) on which is stored the instructions 524 (e.g., software) embodying any one or more of the methodologies or functions described herein. The instructions 524 may also reside, completely or at least partially, within the main memory 504, within the processor 502 (e.g., within the processor's cache memory), or both, before or during execution thereof by the machine 500. Accordingly, the main memory 504 and the processor 502 may be considered as machine-readable media (e.g., tangible and non-transitory machine-readable media). The instructions 524 may be transmitted or received over a network 526 via the network interface device 520.

In some example embodiments, the machine 500 may be a portable computing device and have one or more additional input components (e.g., sensors or gauges). Examples of such input components include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

### Executable Instructions and Machine-Storage Medium

The various memories (i.e., 504, 506, and/or memory of the processor(s) 502) and/or storage unit 516 may store one or more sets of instructions and data structures (e.g., software) 524 embodying or utilized by any one or more of the methodologies or functions described herein. These instructions, when executed by processor(s) 502 cause various operations to implement the disclosed embodiments.

As used herein, the terms “machine-storage medium,” “device-storage medium,” “computer-storage medium” (referred to collectively as “machine-storage medium 522”) mean the same thing and may be used interchangeably in this disclosure. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage media, computer-storage media, and/or device-storage media 522 include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms machine-storage media, computer-storage media, and device-storage media 522 specifically exclude carrier waves, modulated data signals, and other such media, at least some of which are covered under the term “signal medium” discussed below. In this context, the machine-storage medium is non-transitory.

### Signal Medium

The term “signal medium” or “transmission medium” shall be taken to include any form of modulated data signal, carrier wave, and so forth. The term “modulated data signal” means a signal that has one or more of its characteristics set or changed in such a matter as to encode information in the signal.

### Computer Readable Medium

The terms “machine-readable medium,” “computer-readable medium” and “device-readable medium” mean the same thing and may be used interchangeably in this disclosure. The terms are defined to include both machine-storage media and signal media. Thus, the terms include both storage devices/media and carrier waves/modulated data signals.

The instructions 524 may further be transmitted or received over a communications network 526 using a transmission medium via the network interface device 520 and utilizing any one of a number of well-known transfer protocols (e.g., HTTP). Examples of communication networks 526 include a local area network (LAN), a wide area network (WAN), the Internet, mobile telephone networks, plain old telephone service (POTS) networks, and wireless data networks (e.g., WiFi, LTE, and WiMAX networks). The term “transmission medium” shall be taken to include any intangible medium that is capable of storing, encoding, or carrying instructions 524 for execution by the machine 500, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-storage medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured by software to become a special-purpose processor, the general-purpose processor may be configured as respectively different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

### Examples

Example 1 is a method for determining content to display on a map using a machine learning model. The method comprises detecting, by a network system, an event associated with a transportation service being requested via an application on a client device of a user; accessing, by one or more hardware processors of the network system, real-time data and historical data associated with the user; determining, by the network system, connectivity for a location of the client device; analyzing, by the network system, the accessed data and the connectivity to identify display elements to present on the client device based on the event; and causing presentation of the display elements on the client device.

In example 2, the subject matter of example 1 can optionally include wherein the display elements comprise a level of zoom and content to display on a map.

In example 3, the subject matter of any of examples 1-2 can optionally include wherein the content comprises a number of points of interest, one or more types of points of interests, or communication tools.

In example 4, the subject matter of any of examples 1-3 can optionally include wherein the analyzing comprises determining a familiarity parameter based on the historical data, the familiarity parameter indicating knowledge of the user of the location.

In example 5, the subject matter of any of examples 1-4 can optionally include wherein the analyzing comprises determining a complexity parameter, the complexity parameter indicating a complexity of a pickup point or dropoff point for the transportation service.

In example 6, the subject matter of any of examples 1-5 can optionally include wherein the analyzing comprises determining an elasticity parameter based on the historical data, the elasticity parameter indicating willingness of the user to move from their current position to facilitate a pickup.

In example 7, the subject matter of any of examples 1-6 can optionally include wherein the analyzing comprises applying a machine learning model to two or more of the event, the connectivity, a familiarity parameter, a complexity parameter, or an elasticity parameter.

In example 8, the subject matter of any of examples 1-7 can optionally include wherein the accessing real-time data comprises accessing sensor information from one or more sensors associated with the user device, the sensor information including a location of the user device.

In example 9, the subject matter of any of examples 1-8 can optionally include wherein the determining connectivity comprises determining a load time for an area that the user device is located.

In example 10, the subject matter of any of examples 1-9 can optionally include wherein the determining connectivity comprises detecting real-time connectivity status of the user device, the real-time connectivity status including battery life of the user device and network strength of a connection.

In example 11, the subject matter of any of examples 1-10 can optionally include wherein detecting the event comprises detecting one of opening of a client application on the user device, searching for a destination on the client application, confirming a request for the transportation service on the client application, navigating to a pickup point, arriving at a pickup point, or start of a trip.

Example 12 is a system for determining content to display on a map using a machine learning model. The system comprises one or more hardware processors and a memory storing instructions that, when executed by the one or more hardware processors, cause the one or more hardware processors to perform operations comprising detecting an event associated with a transportation service being requested via an application on a client device of a user; accessing real-time data and historical data associated with the user; determining connectivity for a location of the client device; analyzing the accessed data and the connectivity to identify display elements to present on the client device based on the event; and causing presentation of the display elements on the client device.

In example 13, the subject matter of example 12 can optionally include wherein the display elements comprise a level of zoom and content to display on a map.

In example 14, the subject matter of any of examples 12-13 can optionally include wherein the content comprises a number of points of interest, one or more types of points of interests, or communication tools.

In example 15, the subject matter of any of examples 12-14 can optionally include wherein the analyzing comprises determining a familiarity parameter based on the historical data, the familiarity parameter indicating knowledge of the user of the location.

In example 16 the subject matter of any of examples 12-15 can optionally include wherein the analyzing comprises determining a complexity parameter, the complexity parameter indicating a complexity of a pickup point or dropoff point for the transportation service.

In example 17, the subject matter of any of examples 12-16 can optionally include wherein the analyzing comprises determining an elasticity parameter based on the historical data, the elasticity parameter indicating willingness of the user to move from their current position to facilitate a pickup.

In example 18, the subject matter of any of examples 12-17 can optionally include wherein the analyzing comprises applying a machine learning model to two or more of the event, the connectivity, a familiarity parameter, a complexity parameter, or an elasticity parameter.

In example 19, the subject matter of any of examples 12-18 can optionally include wherein the determining connectivity comprises determining a load time for an area that the user device is located or detecting real-time connectivity status of the user device, the real-time connectivity status including battery life of the user device and network strength of a connection.

Example 20 is a computer-storage medium comprising instructions which, when executed by one or more hardware processors of a machine, cause the machine to perform operations for determining content to display on a map using a machine learning model. The operations comprise detecting an event associated with a transportation service being requested via an application on a client device of a user; accessing real-time data and historical data associated with the user; determining connectivity for a location of the client device; analyzing the accessed data and the connectivity to identify display elements to present on the client device based on the event; and causing presentation of the display elements on the client device

Some portions of this specification may be presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

Although an overview of the present subject matter has been described with reference to specific example embodiments, various modifications and changes may be made to these embodiments without departing from the broader scope of embodiments of the present invention. For example, various embodiments or features thereof may be mixed and matched or made optional by a person of ordinary skill in the art. Such embodiments of the present subject matter may be referred to herein, individually or collectively, by the term “invention” merely for convenience and without intending to voluntarily limit the scope of this application to any single invention or present concept if more than one is, in fact, disclosed.

The embodiments illustrated herein are believed to be described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A method comprising:
detecting, by a network system, an event associated with a transportation service being requested via an application on a client device of a user;
accessing, by one or more hardware processors of the network system, real-time data and historical data associated with the user;
determining, by the network system, connectivity for a location of the client device;
analyzing, by the network system, the accessed data and the connectivity to identify display elements to present on the client device based on the event; and
causing presentation of the display elements on the client device.

2. The method of claim 1, wherein the display elements comprise a level of zoom and content to display on a map.

3. The method of claim 2, wherein the content comprises a number of points of interest, one or more types of points of interests, or communication tools.

4. The method of claim 1, wherein the analyzing comprises determining a familiarity parameter based on the historical data, the familiarity parameter indicating knowledge of the user of the location.

5. The method of claim 1, wherein the analyzing comprises determining a complexity parameter, the complexity parameter indicating a complexity of a pickup point or dropoff point for the transportation service.

6. The method of claim 1, wherein the analyzing comprises determining an elasticity parameter based on the historical data, the elasticity parameter indicating willingness of the user to move from their current position to facilitate a pickup.

7. The method of claim 1, wherein the analyzing comprises applying a machine learning model to two or more of the event, the connectivity, a familiarity parameter, a complexity parameter, or an elasticity parameter.

8. The method of claim 1, wherein the accessing real-time data comprises accessing sensor information from one or more sensors associated with the user device, the sensor information including a location of the user device.

9. The method of claim 1, wherein the determining connectivity comprises determining a load time for an area that the user device is located.

10. The method of claim 1, wherein the determining connectivity comprises detecting real-time connectivity status of the user device, the real-time connectivity status including battery life of the user device and network strength of a connection.

11. The method of claim 1, wherein detecting the event comprises detecting one of:
opening of a client application on the user device,
searching for a destination on the client application,
confirming a request for the transportation service on the client application,
navigating to a pickup point,
arriving at a pickup point, or
start of a trip.

12. A system comprising:
one or more hardware processors; and
a storage medium storing instructions that, when executed by the one or more hardware processors, cause the one or more hardware processors to perform operations comprising:
detecting an event associated with a transportation service being requested via an application on a client device of a user;
accessing real-time data and historical data associated with the user;
determining connectivity for a location of the client device;
analyzing the accessed data and the connectivity to identify display elements to present on the client device based on the event; and
causing presentation of the display elements on the client device.

13. The system of claim 12, wherein the display elements comprise a level of zoom and content to display on a map.

14. The system of claim 13, wherein the content comprises a number of points of interest, one or more types of points of interests, or communication tools.

15. The system of claim 12, wherein the analyzing comprises determining a familiarity parameter based on the historical data, the familiarity parameter indicating knowledge of the user of the location.

16. The system of claim 12, wherein the analyzing comprises determining a complexity parameter, the complexity parameter indicating a complexity of a pickup point or dropoff point for the transportation service.

17. The system of claim 12, wherein the analyzing comprises determining an elasticity parameter based on the historical data, the elasticity parameter indicating willingness of the user to move from their current position to facilitate a pickup.

18. The system of claim 12, wherein the analyzing comprises applying a machine learning model to two or more of the event, the connectivity, a familiarity parameter, a complexity parameter, or an elasticity parameter.

19. The system of claim 12, wherein the determining connectivity comprises determining a load time for an area that the user device is located or detecting real-time connectivity status of the user device, the real-time connectivity status including battery life of the user device and network strength of a connection.

20. A machine-storage medium storing instructions that, when executed by one or more processors of a machine, cause the machine to perform operations comprising:
detecting an event associated with a transportation service being requested via an application on a client device of a user;
accessing real-time data and historical data associated with the user;
determining connectivity for a location of the client device;
analyzing the accessed data and the connectivity to identify display elements to present on the client device based on the event; and
causing presentation of the display elements on the client device.
